(19) United States
(12) Patent Application Publication
(10) Pub. No.: US 2024/0427364 A1
(43) Pub. Date: Dec. 26, 2024

(54) METHODS AND APPARATUS TO CURRENT LIMIT REGULATOR CIRCUITRY

(71) Applicant: Texas Instruments Incorporated, Dallas, TX (US)

(72) Inventors: Bumkil Lee, Allen, TX (US); Lei Chen, Plano, TX (US); Chienyu Huang, Plano, TX (US)

(21) Appl. No.: 18/214,422

(22) Filed: Jun. 26, 2023

(51) Int. Cl. G05F 1/565; G05F 1/575; G05F 1/59

(52) U.S. Cl. CPC G05F 1/565; G05F 1/575; G05F 1/59

(57) ABSTRACT

An example apparatus includes: regulator circuitry having a first terminal and a second terminal; current sense circuitry having a first terminal, a second terminal, and a third terminal; the first terminal of the current sense circuitry coupled to the first terminal of the regulator circuitry, the second terminal of the current sense circuitry coupled to the second terminal of the regulator circuitry; and current limit circuitry including: a transistor having a first current terminal, a second current terminal, and a control terminal, the first current terminal coupled to the third terminal of the current sense circuitry, the control terminal coupled to the second terminal of the regulator circuitry; and current source circuitry having a terminal coupled to the second current terminal of the transistor.

### TECHNICAL FIELD

This description relates generally to current limiting circuitry and, more particularly, to methods and apparatus to current limit regulator circuitry.

### BACKGROUND

Continuing advancements in electronics have resulted in circuitry capable of consuming an increasing amount of power. Regulator circuitry receives power from a power supply (e.g., battery, voltage supply, current supply, etc.) and supplies a fixed output voltage to a load (e.g., additional circuitry). The fixed output voltage is configurable based on a voltage from the power supply and a resistance of the load. To maintain the fixed voltage output, the regulator circuitry modifies a current being supplied to the load.

### SUMMARY

For methods and apparatus to current limit regulator circuitry, an example apparatus includes regulator circuitry having a first terminal and a second terminal; current sense circuitry having a first terminal, a second terminal, and a third terminal; the first terminal of the current sense circuitry coupled to the first terminal of the regulator circuitry, the second terminal of the current sense circuitry coupled to the second terminal of the regulator circuitry; and current limit circuitry including: a transistor having a first current terminal, a second current terminal, and a control terminal, the first current terminal coupled to the third terminal of the current sense circuitry, the control terminal coupled to the second terminal of the regulator circuitry; and current source circuitry having a terminal coupled to the second current terminal of the transistor.

### BRIEF DESCRIPTION OF THE DRAWINGS

FIG. 1 is a block diagram of a vehicle including current monitoring circuitry configured to limit a current supplied by regulator circuitry to a load, in an example.

FIG. 2 is a block diagram of the regulator circuitry of FIG. 1 and the current monitoring circuitry of FIG. 1, in an example.

FIG. 3 is a schematic diagram of an example implementation of the regulator circuitry of FIGS. 1 and 2 and the current monitoring circuitry of FIGS. 1 and 2.

FIG. 4 is a timing diagram of an example operation of the regulator circuitry of FIGS. 1-3 and the current monitoring circuitry of FIGS. 1-3.

FIG. 5 is a flowchart representative of example operations that may be executed, instantiated, and/or performed using the current monitoring circuitry of FIGS. 1-3.

### DETAILED DESCRIPTION

The drawings are not necessarily to scale. Generally, the same reference numbers in the drawing(s) and this description refer to the same or like parts. Although the drawings show regions with clean lines and boundaries, some or all of these lines and/or boundaries may be idealized. In reality, the boundaries and/or lines may be unobservable, blended and/or irregular.

Continuing advancements in electronics have resulted in circuitry capable of consuming an increasing amount of power. Regulator circuitry receives power from a power supply (e.g., battery, voltage supply, current supply, etc.) and supplies a fixed output voltage to a load (e.g., additional circuitry). The fixed output voltage is configurable based on a voltage from the power supply and a resistance of the load. To maintain the fixed voltage output, the regulator circuitry modifies a current being supplied to the load.

In operation, an output of the regulator circuitry may become soft-connected or shorted to ground. The regulator circuitry may be soft-connected when the load is decoupled from the regulator circuitry. In such operations, the resistance of the load decreases. The regulator circuitry compensates for the decrease in the resistance of the load by increasing the current being supplied. The regulator circuitry maintains the fixed output voltage in response to the increase in an output current. However, in applications where the resistance of the load is relatively small compared to the designed load, the regulator circuitry needs to supply a relatively high current to maintain the fixed output voltage. Such relatively high currents may damage components of the regulator circuitry.

Examples described herein include methods and apparatus to current limit regulator circuitry. In some described examples, current monitoring circuitry limits current flowing through the regulator circuitry to one of a first current limit or a second current limit. The current monitoring circuitry includes current sense circuitry and current limit circuitry. The current sense circuitry provides a current path from a power supply to the current limit circuitry. The current path of the current sense circuitry is parallel to a current path of the regulator circuitry. The current limit circuitry includes low-limit circuitry and foldback circuitry coupled to the current path from the power supply. The current limit circuitry sets a first and second current limit on the output of the regulator circuitry.

In example operation, the current sense circuitry limits the current flowing through the regulator circuitry to the first current limit when the output voltage of the regulator circuitry is greater than or equal to a threshold voltage. Once the output voltage of the regulator circuitry is less than the threshold voltage, the output voltage of the regulator circuitry disables the foldback circuitry. The current sense circuitry limits the output current of the regulator circuitry to the second current limit responsive to the foldback circuitry being disabled. Advantageously, the current limit circuitry modifies the current limit based on the output voltage of the regulator circuitry. Advantageously, the current limit circuitry prevents the regulator circuitry from sourcing a current greater than a current limit of the current limit circuitry.

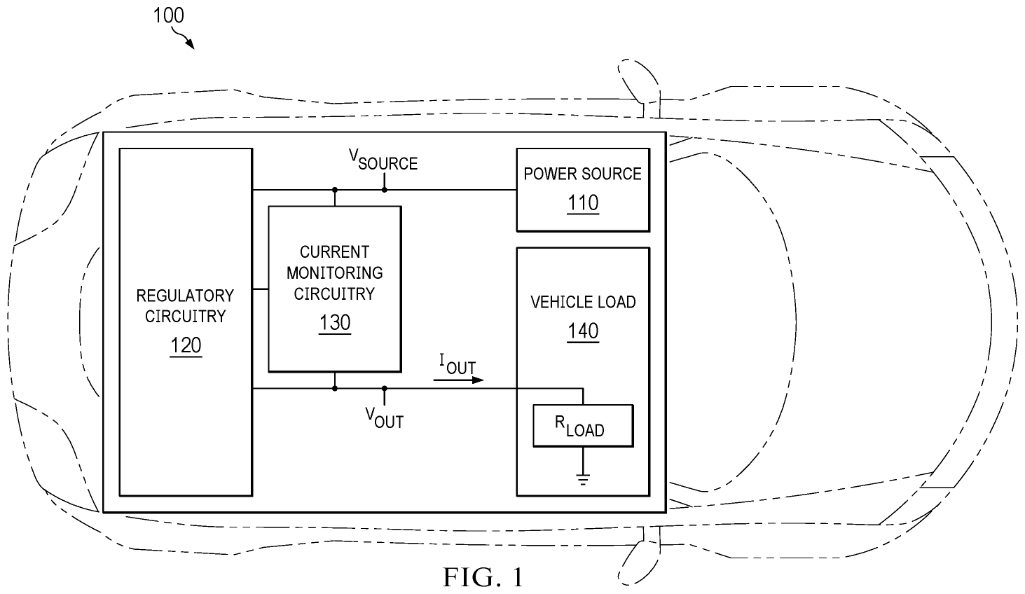

FIG. 1 is a block diagram of an example vehicle 100. In the example of FIG. 1, the vehicle 100 includes an example power source 110, example regulator circuitry 120, example current monitoring circuitry 130, and an example vehicle load 140. The vehicle 100 utilizes a fixed output voltage of the regulator circuitry 120 to supply power to various systems represented by the vehicle load 140.

The power source 110 is coupled to the regulator circuitry 120 and the current monitoring circuitry 130. The power source 110 supplies power to the regulator circuitry 120. In some examples, the power source 110 supplies a fixed voltage and a current that may vary to the regulator circuitry 120. In other examples, the power source 110 supplies a fixed current and a voltage that may vary to the regulator circuitry 120. In yet another example, the power source 110 may supply a fixed power to the regulator circuitry 120.

The regulator circuitry 120 has an input coupled to the power source 110 and the current monitoring circuitry 130. The regulator circuitry 120 has a first output coupled to the current monitoring circuitry 130 and the vehicle load 140. The regulator circuitry 120 has a second output coupled to the current monitoring circuitry 130. The regulator circuitry 120 receives power from the power source 110. The regulator circuitry 120 regulates an output current (I_{OUT}) to generate a fixed output voltage (V_{OUT}) at the second terminal of the regulator circuitry 120. The fixed output voltage is approximately equal to the output current of the regulator circuitry 120 multiplied with an impedance of the vehicle load 140. The regulator circuitry 120 supplies the output current to the vehicle load 140 to generate the fixed output voltage.

The current monitoring circuitry 130 has a first terminal coupled to the power source 110 and the regulator circuitry 120. The current monitoring circuitry 130 has a second terminal coupled to the regulator circuitry 120 and the vehicle load 140. The current monitoring circuitry 130 limits a current flowing through the regulator circuitry 120 based on the output voltage of the regulator circuitry 120. The current monitoring circuitry 130 limits the current flowing through the regulator circuitry 120 to a first current limit when the output voltage is greater than or equal to a threshold voltage. The current monitoring circuitry 130 limits the current flowing through the regulator circuitry 120 to a second current limit when the output voltage is less than the threshold voltage. Advantageously, the current monitoring circuitry 130 prevents the regulator circuitry 120 from sourcing a current greater than the first and second current limit.

The vehicle load 140 is coupled to the regulator circuitry 120 and the current monitoring circuitry 130. The vehicle load 140 receives the output current from the regulator circuitry 120. The output voltage of the regulator circuitry 120 is approximately equal to an impedance (R_{LOAD}) of the vehicle load 140 times the output current of the regulator circuitry 120. In some examples, the vehicle load 140 represents an impedance of external circuitry coupled to the regulator circuitry 120. In other examples, the vehicle load 140 represents components of the vehicle 100, such as motors, controllers, etc.

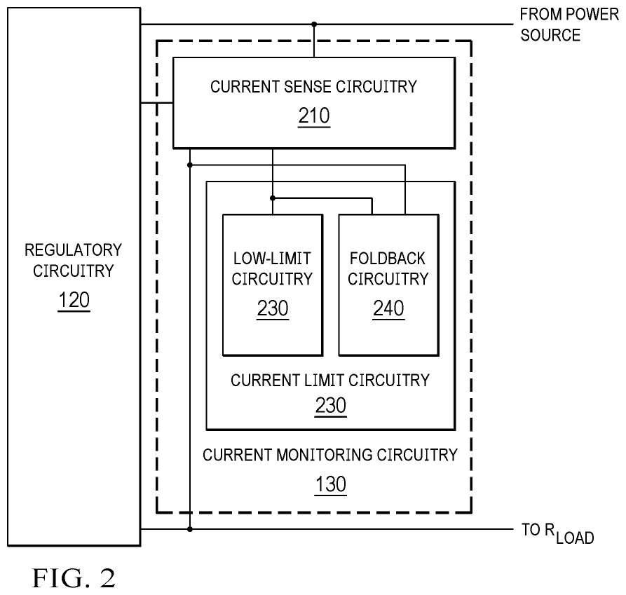

FIG. 2 is a block diagram of the regulator circuitry 120 of FIG. 1 and the current monitoring circuitry 130 of FIG. 1. In the example of FIG. 2, the current monitoring circuitry 130 includes example current sense circuitry 210 and example current limit circuitry 220. The current monitoring circuitry 130 limits the current flowing through the regulator circuitry 120 based on a current limit from the current limit circuitry 220.

The current sense circuitry 210 has a first terminal coupled to the input of the regulator circuitry 120. The current sense circuitry 210 has a second terminal coupled to the first output of the regulator circuitry 120. The current sense circuitry 210 has a third terminal coupled to the second output of the regulator circuitry 120. The current sense circuitry 210 has a fourth terminal coupled to the current limit circuitry 220.

The current sense circuitry 210 replicates a current flowing through the regulator circuitry 120. In some examples, the current sense circuitry 210 replicates the current flowing through the regulator circuitry 120 based on the second output of the regulator circuitry 120. For example, the current sense circuitry 210 may replicate a current through a transistor of the regulator circuitry 120 by sharing a common gate voltage. In such an example, the common gate voltage may be the second output of the regulator circuitry 120. The current sense circuitry 210 generates a first voltage difference based on the replicated output current.

The current sense circuitry 210 generates a second voltage difference based on a current limit from the current limit circuitry 220. In some examples, the current limit may be represented by a current being sourced from the current sense circuitry 210 by the current limit circuitry 220. For example, the current limit is approximately one Ampere (A) when the current limit circuitry 220 sources one Ampere from the current sense circuitry 210.

The current sense circuitry 210 compares the first and second voltage differences. The current sense circuitry 210 determines that the current flowing through the regulator circuitry 120 is approximately equal to or greater than the current limit when the first and second voltage differences are approximately equal or greater than zero. The current sense circuitry 210 prevents the current flowing through the regulator circuitry 120 from increasing beyond the current limit from the current limit circuitry 220.

The current limit circuitry 220 has a first terminal coupled to the regulator circuitry 120 and the current sense circuitry 210. The current limit circuitry 220 has a second terminal coupled to the current sense circuitry 210. In the example of FIG. 2, the current limit circuitry 220 includes low-limit circuitry 230 and foldback circuitry 230. The current limit circuitry 220 sets the current limit of the current sense circuitry 210.

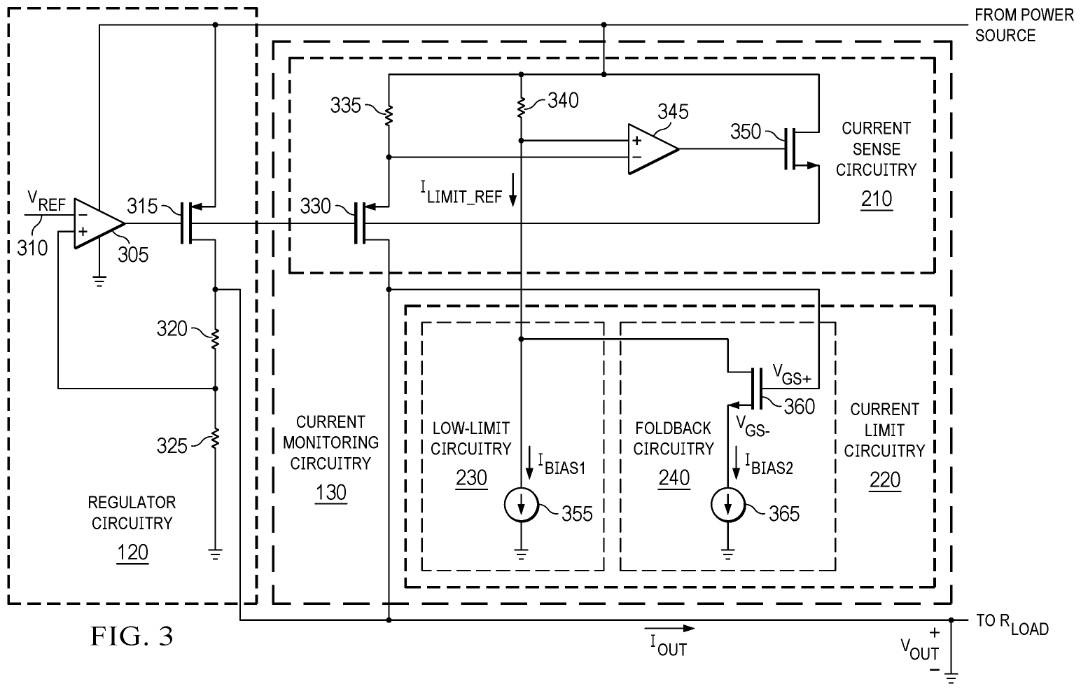

The low-limit circuitry 230 is coupled to the current sense circuitry 210 and the foldback circuitry 240. The low-limit circuitry 230 sources a first bias current (I_{BIAS1}) from the current sense circuitry 210. I_{BIAS1} is shown in FIG. 3.

The foldback circuitry 240 has a first terminal coupled to the current sense circuitry 210 and the low-limit circuitry 230. The foldback circuitry 240 has a second terminal coupled to the regulator circuitry 120 and the current sense circuitry 210. The foldback circuitry sources a second bias current (I_{BIAS2}) from the current sense circuitry 210 based on the output voltage of the regulator circuitry 120. I_{BIAS2} is shown in FIG. 3. The foldback circuitry 240 sources the second bias current when the output voltage of the regulator circuitry 120 is greater than or equal to a threshold voltage. The foldback circuitry 240 sources approximately zero current when the output voltage of the regulator circuitry 120 is less than the threshold voltage.

In an example operation, the current limit circuitry 220 sources a first current when the output voltage of the regulator circuitry 120 is greater than or equal to the threshold voltage of the foldback circuitry 240. In such an example operation, the current limit of the current sense circuitry 210 is approximately equal to an addition of the first and second bias currents. In another example operation, current limit circuitry 220 sources a second current when the output voltage of the regulator circuitry 120 is less than the threshold voltage of the foldback circuitry 240. In such an example operation, the current limit of the current sense circuitry 210 is approximately equal to the first bias current of the low-limit circuitry 230. Advantageously, the current monitoring circuitry 130 prevents the regulator circuitry 120 from sourcing a relatively high current to compensate for loads with relatively low resistances and/or impedances. For example, if the vehicle load 140 of FIG. 1 were suddenly disconnected or shorted.

FIG. 3 is a schematic diagram of an example implementation of the regulator circuitry 120 of FIGS. 1 and 2 and the current monitoring circuitry 130 of FIGS. 1 and 2. In the example of FIG. 1, the regulator circuitry 120 includes a first example amplifier 305, an example reference voltage 310, a first example transistor 315, a first example resistor 320, and a second example resistor 325. The regulator circuitry 120 may be referred to as a linear regulator. Alternatively, the regulator circuitry 120 may be modified in accordance with the teachings disclosed herein to include alternate regulator circuitry.

The first amplifier 305 has an inverting input coupled to the reference voltage 310. The first amplifier 305 has a non-inverting input coupled to the resistors 320 and 325. The first amplifier 305 has a first supply input coupled to the current monitoring circuitry 130. The first amplifier 305 has a second supply input coupled to a common potential (e.g., ground). The first amplifier 305 has an output coupled to the current monitoring circuitry 130 and the first transistor 315. The first amplifier 305 controls the first transistor 315. The first amplifier 305 causes a current to flow through the first transistor 315 to generate a voltage at the non-inverting input of the first amplifier 305 approximately equal to the reference voltage 310. For example, the first amplifier 305 may modify the output of the first amplifier 305 to increase the current flowing through the first transistor 315 when the voltage of the non-inverting input of the first amplifier 305 is less than the first reference voltage 310.

The first transistor 315 has a first current terminal coupled to the current monitoring circuitry 130 and the first amplifier 305. The first transistor 315 has a second current terminal coupled to the current monitoring circuitry 130 and the first resistor 320. The first transistor 315 has a control terminal coupled to the first amplifier 305. The first transistor 315 is controlled by the first amplifier 305. The first transistor 315 allows current to flow between the first current terminal to the second current terminal when turned on (e.g., enabled, conducting). The first transistor 315 prevents current from flowing between the first current terminal to the second current terminal when turned off (e.g., disabled, non-conducting). The first amplifier 305 may partially enable the first transistor 315 to control a magnitude of current flowing through the first transistor 315. In the example of FIG. 3, the first transistor 315 is a p-channel metal-oxide semiconductor field-effect transistor (MOSFET). Alternatively, the first transistor 315 may be a p-channel field-effect transistor (FET), a p-channel insulated-gate bipolar transistor (IGBT), a p-channel junction field effect transistor (JFET), a PNP bipolar junction transistor (BJT) and/or, with slight modifications, an n-type equivalent device.

The first resistor 320 has a first terminal coupled to the current monitoring circuitry 130 and the first transistor 315. The first resistor 320 has a second terminal coupled to the first amplifier 305 and the second resistor 325. The first resistor 320 has a first resistance. The second resistor 325 has a first terminal coupled to the first amplifier 305 and the first resistor 320. The second resistor 325 has a second terminal coupled to the common potential. The second resistor 325 has a second resistance. The resistors 320 and 325 are configured to be coupled in parallel with a load coupled to the regulator circuitry 120.

The resistors 320 and 325 may be referred to as a voltage divider. The resistors 320 and 325 set the voltage of the non-inverting input of the first amplifier 305. In an example operation, current from the first transistor 315 causes the resistors 320 and 325 to set the voltage of the non-inverting input of the first amplifier 305 approximately equal to the reference voltage 310. Advantageously, the output voltage of the regulator circuitry 120 is a fixed output voltage when the resistors 320 and 325 set the voltage of non-inverting input of the first amplifier 305 approximately equal to the reference voltage 310.

In the example of FIG. 3, the current sense circuitry 210 includes a second example transistor 330, a third example resistor 335, a fourth example resistor 340, a second example amplifier 345, and a second example transistor 350. The current sense circuitry 210 limits the current flowing through the first transistor 315 of the regulator circuitry 120 to a current limit set by the current limit circuitry 220.

The second transistor 330 has a first current terminal coupled to the third resistor 335. The second transistor 330 has a second current terminal coupled to the regulator circuitry 120 and the current limit circuitry 220. The second transistor 330 has a control terminal coupled to the gate terminal of the first transistor 315. The second transistor 330 is controlled by the output of the first amplifier 305. The second transistor 330 allows current to flow between the first current terminal to the second current terminal when turned on. The second transistor 330 prevents current from flowing between the first current terminal to the second current terminal when turned off. In the example of FIG. 3, the current through the second transistor 330 is approximately equal to the current flowing through the first transistor 315. Advantageously, the current flowing through the second transistor 330 is a replica of the current flowing through the first transistor 315. In the example of FIG. 3, the second transistor 330 is a p-channel MOSFET. Alternatively, the second transistor 330 may be a p-channel FET, a p-channel IGBT, a p-channel JFET, a PNP BJT, and/or, with slight modifications, an n-type equivalent device.

The third resistor 335 has a first terminal coupled to the regulator circuitry 120, the fourth resistor 340, and the third transistor 350. The third resistor 335 has a second terminal coupled to the second transistor 330 and the second amplifier 345. The third resistor 335 has a resistance. The third resistor 335 creates a first voltage difference between the first terminal and the second terminal proportional to the current flowing through the second transistor 330.

The fourth resistor 340 has a first terminal coupled to the regulator circuitry 120, the third resistor 335, and the third transistor 350. The fourth resistor 340 has a second terminal coupled to the current limit circuitry 220. The fourth resistor 340 has a resistance. The fourth resistor 340 creates a second voltage difference between the first terminal and the second terminal proportional to the current being sourced by the current limit circuitry 220.

The second amplifier 345 has an inverting input coupled to the second transistor 330 and the third resistor 335. The second amplifier 345 has a non-inverting input coupled to current limit circuitry 220 and the fourth resistor 340. The second amplifier 345 has an output coupled to the third transistor 350. The second amplifier 345 controls the third transistor 350 based on a voltage difference between the inverting and non-inverting inputs.

The third transistor 350 has a first current terminal coupled to the regulator circuitry 120 and the resistors 335 and 340. The third transistor 350 has a second current terminal coupled to the regulator circuitry 120 and the second transistor 330. The third transistor 350 has a control terminal coupled to the second amplifier 345. The third transistor 350 is controlled by the output of the second amplifier 345. The third transistor 350 allows current to flow between the first current terminal to the second current terminal when turned on. The third transistor 350 prevents current from flowing between the first current terminal to the second current terminal when turned off. In the example of FIG. 3, the third transistor 350 is an n-channel MOSFET. Alternatively, the third transistor 350 may be an n-channel FET, an n-channel IGBT, an n-channel JFET, an NPN BJT, and/or, with slight modifications, a p-type equivalent device.

In example operation, the first amplifier 305 controls the first transistor 315 to cause the non-inverting input of the first amplifier 305 to be approximately equal to the reference voltage 310. The second transistor 330 replicates the current flowing through the first transistor 315. The third resistor 335 creates the first voltage difference proportional to the replicated current of the second transistor 330 and the resistance of the third resistor 335.

In such an example operation, the fourth resistor 340 creates a second voltage difference proportional to the current limit that the current limit circuitry 220 is sourcing. The second amplifier 345 determines a third voltage difference between voltages created by the first and second voltage differences of the resistors 335 and 340. The second amplifier 345 turns on the third transistor 350 when the first voltage difference is greater than to the second voltage difference. The third transistor 350 turns off the transistors 315 and 330 when turned on by the second amplifier 345. The second amplifier 345 turns off the third transistor 350 when the first voltage difference is less than the second voltage difference. The transistors 315 and 330 operate without being limited when the third transistor 350 is turned off.

In the example of FIG. 3, the low-limit circuitry 230 includes first example current source circuitry 355. The first current source circuitry 355 has a first terminal coupled to the foldback circuitry 240, the fourth resistor 340, and the second amplifier 345. The first current source circuitry 355 has a second terminal coupled to the common potential. The first current source circuitry 355 sources a first bias current (I_{BIAS1}) from the current sense circuitry 210.

In the example of FIG. 3, the foldback circuitry 240 includes a fourth example transistor 360 and second example current source circuitry 365. The fourth transistor 360 has a first current terminal coupled to the low-limit circuitry 230, the fourth resistor 340, and the second amplifier 345. The fourth transistor 360 has a second current terminal coupled to the second current source circuitry 365. The fourth transistor 360 has a control terminal coupled to the regulator circuitry 120 and the current sense circuitry 210. The fourth transistor 360 is controlled by the output voltage of the regulator circuitry 120. The fourth transistor 360 allows current to flow between the first current terminal to the second current terminal when turned on. The fourth transistor 360 prevents current from flowing between the first current terminal to the second current terminal when turned off. In the example of FIG. 3, the fourth transistor 360 is an n-channel MOSFET. Alternatively, the fourth transistor 360 may be an n-channel FET, an n-channel IGBT, an n-channel JFET, a NPN BJT, and/or, with slight modifications, a p-type equivalent device.

The second current source circuitry 365 has a first terminal coupled to the fourth transistor 360. The second current source circuitry 365 has a second terminal coupled to the common potential. The second current source circuitry 365 sources a second bias current (I_{BIAS2}) from the current sense circuitry 210.

In example operation, the output voltage of the regulator circuitry 120 turns on the fourth transistor 360. For example, a gate-to-source voltage (V_{GS}) of the fourth transistor 360 is greater than or equal to a threshold voltage of the fourth transistor 360. The fourth transistor 360 allows the second current source circuitry 365 to source the second bias current from the current sense circuitry 210. In such an operation, the current limit circuitry 220 sources a total current approximately equal to the combination of the first and second bias currents of the current source circuitries 355 and 365. Advantageously, when the output voltage of the regulator circuitry 120 is greater than the threshold voltage of the fourth transistor 360, the current limit circuitry 220 sets the current limit to a first current limit approximately equal to the combination of the bias currents of the current source circuitries 355 and 365.

In another example operation, the output voltage of the regulator circuitry 120 turns off the fourth transistor 360 when, for example, the gate-to-source voltage of the fourth transistor 360 is less than the threshold voltage of the fourth transistor 360. The fourth transistor 360 prevents the second current source circuitry 365 from sourcing the second bias current from the current sense circuitry 210. In such an operation, the current limit circuitry 220 sources a total current approximately equal to the first bias current of the first current source circuitry 355. Advantageously, when the output voltage of the regulator circuitry 120 is less than the threshold voltage of the fourth transistor 360, the current limit circuitry 220 sets the current limit to a second current limit approximately equal to the first bias current of the first current source circuitry 355.

In an example operation, when a resistance of a load (e.g., the vehicle load 140 of FIG. 1) configured to be coupled to the output of the regulator circuitry 120 decreases, the first amplifier 305 attempts to maintain the fixed output voltage by increasing the current flowing through the first transistor 315. For example, the output of the regulator circuitry 120 becomes soft connected, disconnected, etc. In some example operations, the resistance of the load decreases to a resistance that causes the first amplifier 305 to configure the first transistor 315 to source a current greater than the first current limit of the current source circuitries 355 and 365. In such example operations, the second transistor 330 replicates the increased current causing the first voltage difference from the third resistor 335 to increase. The increase in the first voltage difference causes the second amplifier 345 to turn on the third transistor 350 and limit any further increase in current flowing through the transistors 315 and 330. Advantageously, limiting the current flowing through the transistors 315 and 330 prevents the first amplifier 305 from causing the first transistor 315 to source a current greater than a maximum current of the first transistor 315.

In an example operation where the resistance of the load continues to decrease, the decreasing resistance and the limited current flow through the transistors 315 and 330 cause the output voltage of the regulator circuitry 120 to decrease. In such an example operation, the output voltage of the regulator circuitry 120 continues to decrease with the resistance of the load. The decreasing output voltage turns off the fourth transistor 360 when the output voltage of the regulator circuitry 120 is less than the threshold voltage of the fourth transistor 360. Once the fourth transistor 360 is turned off, the second amplifier 345 limits the current flowing through the transistors 315 and 330 to the first bias current of the first current source circuitry 355. Advantageously, a decreasing output voltage of the regulator circuitry 120 causes the current limit circuitry 220 to reduce the output current based on the second current limit of the first current source circuitry 355. Advantageously, the current sense circuitry 210 and the current limit circuitry 220 prevent the first transistor 315 from sourcing a current capable of damaging the regulator circuitry 120 and/or a load coupled to the regulator circuitry 120.

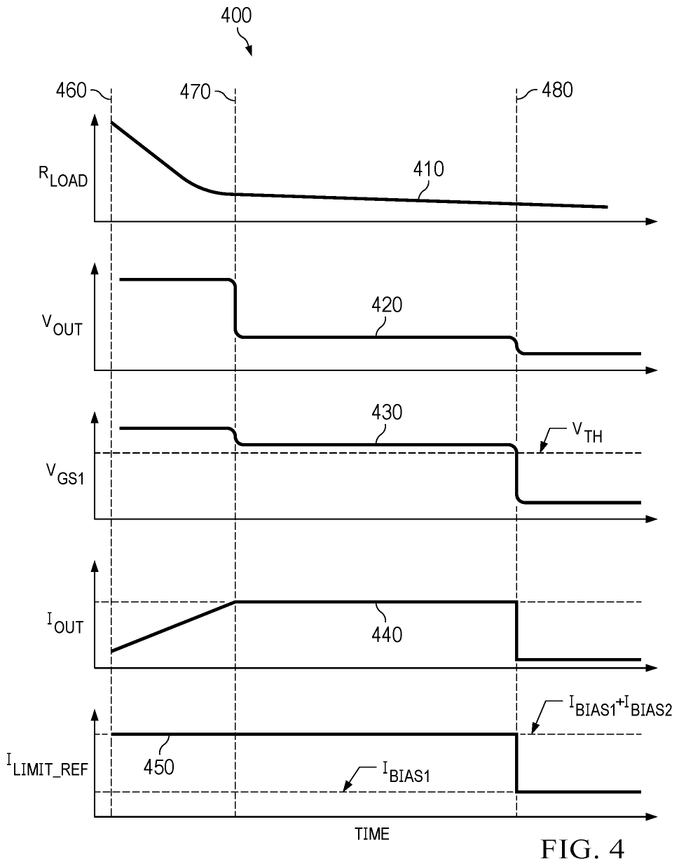

FIG. 4 is a timing diagram 400 of an example operation of the regulator circuitry 120 of FIGS. 1-3 and the current monitoring circuitry 130 of FIGS. 1-3. In the example of FIG. 4, the timing diagram 400 includes an example load resistance (R_{load}) 410, an example output voltage (V_{OUT}) 420, an example foldback gate-to-source voltage (V_{GS1}) 430, an example output current (I_{OUT}) 440, and an example current limit (I_{limit_ref}) 450. The timing diagram 400 illustrates current limiting operations of the current monitoring circuitry 130.

The load resistance 410 represents a resistance of a load coupled to the regulator circuitry 120 over time. For example, the load resistance 410 may represent the vehicle load 140 of FIG. 1 over time. The output voltage 420 represents the output voltage of the regulator circuitry 120 over time. The foldback gate-to-source voltage 430 represents the gate-to-source voltage of the fourth transistor 360 of FIG. 3. The foldback gate-to-source voltage 430 turns on the fourth transistor 360 when greater than the threshold voltage of the fourth transistor 360. The foldback gate-to-source voltage 430 turns off the fourth transistor 360 when less than the threshold voltage of the fourth transistor 360. The output current 440 represents the output current of the regulator circuitry 120. The current limit 450 represents the current limit from the current limit circuitry 220 of FIGS. 2 and 3.

At a first time 460, the load resistance 410 begins to decrease. In some examples, a soft-connect of the output of the regulator circuitry 120 causes the load resistance 410 to decrease. In other examples, a short to the common potential (e.g., ground) causes the load resistance 410 to decrease. At the first time 460, the output current 440 begins to increase to compensate for the decrease in the load resistance 410. At the first time 460, the increase in the output current 440 causes the output voltage 420 to remain at a fixed voltage despite the decrease in the load resistance 410. At the first time 460, the current limit 450 is a first current limit approximately equal to a combination of the bias currents from the current source circuitries 355 and 365 of FIG. 3. The current limit 450 remains at the first current limit until the output voltage 420 decreases enough to cause the foldback gate-to-source voltage 430 to disable the fourth transistor 360.

At a second time 470, the load resistance 410 decreases to a resistance low enough to cause the output current 440 to increase to a value that is limited by the current monitoring circuitry 130. At the second time 470, the current flowing through the transistors 315 and 330 of FIG. 3 is approximately equal to the current limit 450. At the second time 470, the output voltage 420 decreases as the load resistance 410 continues to decrease while the output current 440 is being limited. At the second time 470, the foldback gate-to-source voltage 430 decreases as a result of the decrease in the output voltage 420.

At a third time 480, the load resistance 410 decreases to a resistance which results in the first current limit causing the output voltage 420 to decrease the foldback gate-to-source voltage 430 below the threshold voltage of the fourth transistor 360. At the third time 480, the foldback gate-to-source voltage 430 disables the fourth transistor 360 causing the current limit 450 to switch to a second current limit approximately equal to the first bias current of the first current source circuitry 355. At the third time 480, the output current 440 decreases in response to the second current limit of the current limit 450.

Advantageously, decreasing the load resistance 410 and the first current limit disable the fourth transistor 360 to change the current limit 450 to the second current limit. Advantageously, the current monitoring circuitry 130 reduces the output current 440 of the regulator circuitry 120 based on the load resistance 410 and the current limit 450.

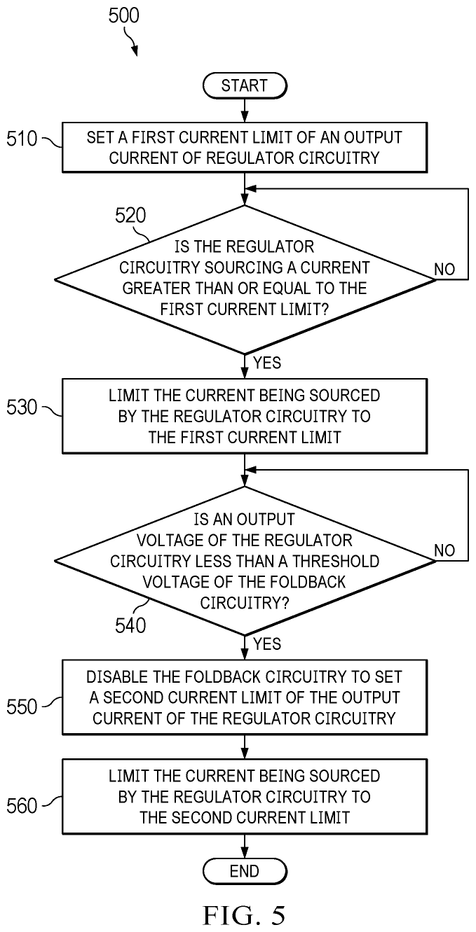

FIG. 5 is a flowchart representative of example operations 500 that may be executed, instantiated, and/or performed using the current monitoring circuitry 130 of FIGS. 1-3. The operations 500 begin at Block 510 wherein, the current limit circuitry 220 of FIGS. 2 and 3 sets a first current limit of an output of the regulator circuitry 120 of FIGS. 1-3. In some examples, the output voltage of the regulator circuitry 120 turns on the fourth transistor 360 of FIG. 3 setting the current limit approximately equal to a combination of the bias currents of the current source circuitries 355 and 365 of FIG. 3.

The current sense circuitry 210 of FIGS. 2 and 3 determines if the regulator circuitry 120 is sourcing a current greater than or equal to the first current limit. (Block 520). In some examples, the second transistor 330 of FIG. 3 replicates the current being sourced by the regulator circuitry 120. In such examples, the second amplifier 345 of FIG. 3 compares voltage differences created by the replicated current and the first current limit to determine if the current being sourced by the regulator circuitry 120 is greater than or equal to the first current limit.

If the current sense circuitry 210 determines the regulator circuitry 120 is not sourcing a current greater than or equal to the first current limit (e.g., Block 520 returns a result of NO), control proceeds to return to Block 520. If the current sense circuitry 210 determines the regulator circuitry 120 is sourcing a current greater than or equal to the first current limit (e.g., Block 520 returns a result of YES), the current sense circuitry 210 limits the current being sourced by the regulator circuitry 120 to the first current limit. (Block 530). In some examples, the second amplifier 345 turns on the third transistor 350 of FIG. 3 to turn off the transistors 315 and 330. In such examples, the second amplifier 345 turns off the third transistor 350 once the current flowing through the transistors 315 and 330 returns to a value approximately equal to the first current limit.

The foldback circuitry 240 of FIGS. 2 and 3 determines if an output voltage of the regulator circuitry 120 is less than a threshold voltage of the foldback circuitry 240. (Block 540). In some examples, the fourth transistor 360 is on while the output voltage of the regulator circuitry 120 causes the gate-to-source voltage of the fourth transistor 360 to be greater than or equal to the threshold voltage of the fourth transistor 360. In such examples, the fourth transistor 360 turns off when the output voltage of the regulator circuitry 120 causes the gate-to-source voltage of the fourth transistor 360 to be less than the voltage threshold.

If the foldback circuitry 240 determines the output voltage of the regulator circuitry 120 is not less than the threshold voltage (e.g., Block 540 returns a result of NO), control proceeds to return to Block 540. If the foldback circuitry 240 determines the output voltage of the regulator circuitry 120 is less than the threshold voltage (e.g., Block 540 returns a result of YES), the fourth transistor 360 disables the foldback circuitry 240 to set a second current limit of the output current of the regulator circuitry 120. (Block 550). In some examples, the fourth transistor 360 turns off, which disables the second current source circuitry 365 from sourcing current from the current sense circuitry 210. In such examples, the voltage difference generated by the current limit is proportional to the first bias current of the first current source circuitry 355.

The current sense circuitry 210 limits the current being sourced by the regulator circuitry 120 to the second current limit. (Block 560). In some examples, the second amplifier 345 turns on the third transistor 350 to turn off the transistors 315 and 330. In such examples, the second amplifier 345 turns off the third transistor 350 once the current flowing through the transistors 315 and 330 returns to a value approximately equal to the second current limit.

In this description, the term “and/or” (when used in a form such as A, B and/or C) refers to any combination or subset of A, B, C, such as: (a) A alone; (b) B alone; (c) C alone; (d) A with B; (c) A with C; (f) B with C; and (g) A with B and with C. Also, as used herein, the phrase “at least one of A or B” (or “at least one of A and B”) refers to implementations including any of: (a) at least one A; (b) at least one B; and (c) at least one A and at least one B.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Numerical identifiers such as “first,” “second,” “third,” etc. are used merely to distinguish between elements of substantially the same type in terms of structure and/or function. These identifiers as used in the detailed description do not necessarily align with those used in the claims.

A device that is “configured to” perform a task or function may be configured (e.g., programmed and/or hardwired) at a time of manufacturing by a manufacturer to perform the function and/or may be configurable (or re-configurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current source circuitries) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor. While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. Unless otherwise stated, “about,” “approximately,” or “substantially” preceding a value means +/−10 percent of the stated value, or, if the value is zero, a reasonable range of values around zero.

Modifications are possible in the described embodiments, and other embodiments are possible, within the scope of the claims.

From the foregoing, it will be appreciated that example systems, apparatus, articles of manufacture, and methods have been described that limit current of regulator circuitry based on the output voltage of the regulator circuitry. Described systems, apparatus, articles of manufacture, and methods are accordingly directed to one or more improvement(s) in the operation of a machine such as a computer or other electronic and/or mechanical device.

What is claimed is:

1. An apparatus comprising:
regulator circuitry having a first terminal and a second terminal;
current sense circuitry having a first terminal, a second terminal, and a third terminal, the first terminal of the current sense circuitry coupled to the first terminal of the regulator circuitry, the second terminal of the current sense circuitry coupled to the second terminal of the regulator circuitry; and
current limit circuitry including:
a transistor having a first current terminal, a second current terminal, and a control terminal, the first current terminal coupled to the third terminal of the current sense circuitry, the control terminal coupled to the second terminal of the regulator circuitry; and
current source circuitry having a terminal coupled to the second current terminal of the transistor.

2. The apparatus of claim 1, wherein the transistor is a first transistor, the regulator circuitry including:
an amplifier having a supply input, a non-inverting input, and an output, the supply input of the amplifier coupled to the first terminal of the current sense circuitry; and
a second transistor having a first current terminal, a second current terminal, and a control terminal, the first current terminal of the second transistor coupled to the first terminal of the current sense circuitry and the supply input of the amplifier, the second current terminal of the second transistor coupled to the second terminal of the current sense circuitry and the control terminal of the first transistor, the control terminal of the second transistor coupled to the output of the amplifier.

3. The apparatus of claim 2, wherein the regulator circuitry further including:
a first resistor having a first terminal and a second terminal, the first terminal of the first resistor coupled to the second terminal of the current sense circuitry, the control terminal of the first resistor, and the second current terminal of the second transistor; and
a second resistor having a terminal coupled to the non-inverting input of the amplifier and the second terminal of the first resistor.

4. The apparatus of claim 1, wherein the regulator circuitry further having a third terminal, the current sense circuitry further having a fourth terminal, the third terminal of the regulator circuitry coupled to the fourth terminal of the current sense circuitry.

5. The apparatus of claim 4, wherein the transistor is a first transistor, the current sense circuitry including:
a resistor having a first terminal and a second terminal, the first terminal of the resistor coupled to the first terminal of the regulator circuitry;
an amplifier having a non-inverting input, an inverting input, and an output, the non-inverting input of the amplifier coupled to the first current terminal of the first transistor and the second terminal of the resistor; and
a second transistor having a first current terminal, a second current terminal, and a control terminal, the first current terminal of the second transistor coupled to the first terminal of the regulator circuitry and the first terminal of the resistor, the second current terminal of the second transistor coupled to the third terminal of the regulator circuitry, the control terminal of the second transistor coupled to the output of the amplifier.

6. The apparatus of claim 5, wherein resistor is a first resistor, the current sense circuitry further including:
a second resistor having a first terminal and a second terminal, the first terminal of the second resistor coupled to the first terminal of the regulator circuitry, the first terminal of the first resistor, and the first current terminal of the second transistor, the second terminal of the second resistor coupled to the inverting input of the amplifier; and
a third transistor having a first current terminal, a second current terminal, and a control terminal, the first current terminal of the third transistor coupled to the inverting input of the amplifier and the second terminal of the second resistor, the second current terminal of the third transistor coupled to the second terminal of the regulator circuitry and the control terminal of the first transistor, the control terminal of the third transistor coupled to the third terminal of the regulator circuitry and the second current terminal of the second transistor.

7. The apparatus of claim 1, wherein the current source circuitry is first current source circuitry, the current limit circuitry further including second current source circuitry having a terminal coupled to the third terminal of the current sense circuitry and the first current terminal of the transistor.

8. A system comprising:
regulator circuitry having a first terminal and a second terminal;
current sense circuitry having a first terminal, a second terminal, and a third terminal;
the first terminal of the current sense circuitry coupled to the first terminal of the regulator circuitry, the second terminal of the current sense circuitry coupled to the second terminal of the regulator circuitry;
current limit circuitry including:
current source circuitry having a terminal coupled to the third terminal of the current sense circuitry; and
foldback circuitry having a control terminal and a current terminal, the control terminal of the foldback circuitry coupled to the second terminal of the regulator circuitry and the second terminal of the current sense circuitry, the current terminal of the foldback circuitry coupled to the third terminal of the current sense circuitry and the terminal of the current source circuitry.

9. The system of claim 8, the regulator circuitry including:
an amplifier having a supply input, a non-inverting input, and an output, the supply input of the amplifier coupled to the first terminal of the current sense circuitry; and
a transistor having a first current terminal, a second current terminal, and a control terminal, the first current terminal of the transistor coupled to the first terminal of the current sense circuitry and the supply input of the amplifier, the second current terminal of the transistor coupled to the second terminal of the current sense circuitry and the control terminal of the foldback circuitry, the control terminal of the transistor coupled to the output of the amplifier.

10. The system of claim 9, wherein the regulator circuitry further including:
a first resistor having a first terminal and a second terminal, the first terminal of the first resistor coupled to the second terminal of the current sense circuitry, the control terminal of the first resistor, and the second current terminal of the transistor; and
a second resistor having a terminal coupled to the non-inverting input of the amplifier and the second terminal of the first resistor.

11. The system of claim 8, wherein the regulator circuitry further having a third terminal, the current sense circuitry further having a fourth terminal, the third terminal of the regulator circuitry coupled to the fourth terminal of the current sense circuitry.

12. The system of claim 11, wherein the current sense circuitry including:
a resistor having a first terminal and a second terminal, the first terminal of the resistor coupled to the first terminal of the regulator circuitry;
an amplifier having a non-inverting input, an inverting input, and an output, the non-inverting input of the amplifier coupled to the control terminal of the foldback circuitry and the second terminal of the resistor; and
a transistor having a first current terminal, a second current terminal, and a control terminal, the first current terminal of the transistor coupled to the first terminal of the regulator circuitry and the first terminal of the resistor, the second current terminal of the transistor coupled to the third terminal of the regulator circuitry, the control terminal of the transistor coupled to the output of the amplifier.

13. The system of claim 12, wherein resistor is a first resistor and the transistor is a first transistor, the current sense circuitry further including:
a second resistor having a first terminal and a second terminal, the first terminal of the second resistor coupled to the first terminal of the regulator circuitry, the first terminal of the first resistor, and the first current terminal of the first transistor, the second terminal of the second resistor coupled to the inverting input of the amplifier; and
a second transistor having a first current terminal, a second current terminal, and a control terminal, the first current terminal of the second transistor coupled to the inverting input of the amplifier and the second terminal of the second resistor, the second current terminal of the second transistor coupled to the second terminal of the regulator circuitry and the control terminal of the foldback circuitry, the control terminal of the second transistor coupled to the third terminal of the regulator circuitry and the second current terminal of the first transistor.

14. The system of claim 8, wherein the current source circuitry is first current source circuitry, the foldback circuitry including:
a transistor having a first current terminal, a second current terminal, and a control terminal, the first current terminal of the transistor coupled to the third terminal of the current sense circuitry, the control terminal of the transistor coupled to the second terminal of the regulator circuitry; and
second current source circuitry having a terminal coupled to the second current terminal of the transistor.

15. A method comprising:
limiting, by current limiting circuitry, a current flowing through regulator circuitry to a first current limit;
sensing, by foldback circuitry, an output voltage of the regulator circuitry is less than a threshold voltage of the foldback circuitry;
disabling, by the regulator circuitry, the foldback circuitry when the output voltage of the regulator circuitry is less than the threshold voltage; and
limiting, by the current limiting circuitry, the current flowing through the regulator circuitry to a second current limit.

16. The method of claim 15, further including setting the output voltage of the regulator circuitry to a fixed voltage.

17. The method of claim 15, further including enabling current source circuitry and the foldback circuitry to set the regulator circuitry to the first current limit.

18. The method of claim 15, further including sensing the regulator circuitry is sourcing a current greater than or equal to the first current limit.

19. The method of claim 15, further including disabling the foldback circuitry to limit the regulator circuitry to the second current limit.

20. The method of claim 15, further including setting the first current limit based on a combination of first current source circuitry and second current source circuitry of the current limiting circuitry.
